(19) United States
(12) Patent Application Publication
(10) Pub. No.: US 2026/0089345 A1
(43) Pub. Date: Mar. 26, 2026

(54) VIDEO CODING COMBINING INTRA-SUB PARTITION AND TEMPLATE-BASED INTRA-MODE DERIVATION TECHNIQUES

(71) Applicant: InterDigital CE Patent Holdings, SAS, Paris (FR)

(72) Inventors: Kevin Reuzé, Rennes (FR); Thierry Dumas, Rennes (FR); Karam Naser, Mouazé (FR); Philippe Bordes, Laille (FR)

(73) Assignee: InterDigital CE Patent Holdings, SAS, Paris (FR)

(21) Appl. No.: 19/113,593

(22) PCT Filed: Oct. 11, 2023
(86) PCT No.: PCT/EP2023/078190

§ 371 Date: Mar. 20, 2025

(30) Foreign Application Priority Data
Oct. 11, 2022 (EP) 22306527.7

(51) Int. Cl. H04N 19/593; H04N 19/176

(52) U.S. Cl. CPC H04N 19/593; H04N 19/176

(57) ABSTRACT

A coding block with ISP enabled may include multiple sub-partitions. For a first sub-partition in the coding block, an intra prediction mode may be derived based on the template samples associated with the first sub-partition. The first sub-partition may be decoded based on the intra prediction mode. For a second sub-partition in the coding block, an intra prediction mode may be derived based on the template samples associated with the second sub-partition, and the second sub-partition may be decoded based on that intra prediction mode. The sub-partitions in the coding block may independently derive an intra prediction mode using decoder side intra mode derivation and/or template-based intra mode derivation.

### CROSS REFERENCE TO RELATED APPLICATIONS

This application claims the benefit of European Provisional Patent Application No. 22306527.7, filed Oct. 11, 2022, the contents of which are hereby incorporated by reference herein.

### BACKGROUND

Video coding systems can be used to compress digital video signals, e.g., to reduce the storage and/or transmission bandwidth needed for such signals. Video coding systems can include, for example, block-based, wavelet-based, and/or object-based systems.

### SUMMARY

Template-based intra mode derivation (TIMD) and intra sub partition (ISP) processes may be combined to use reconstructed samples from ISP in TIMD. Systems, methods, and instrumentalities are disclosed for performing the TIMD process for a sub-partition of a coding block (e.g., a transform unit (TU)). In examples, TIMD may be performed independently for each sub-partition when used with ISP. The order of encoding/decoding may be determined based on identified conditions, which may enable use of more reference samples. In examples, independent sub-partition level TIMD derivation and/or encoding/decoding reordering may be used when ISP sub-partitions are thin and/or small (e.g., sub-partitions with a width or a height less than four).

A coding block with ISP enabled may include multiple sub-partitions. For a first sub-partition in the coding block, a first intra prediction mode may be derived based on the template samples associated with the first sub-partition. The first sub-partition may be decoded based on the intra prediction mode. For a second sub-partition in the coding block, a second intra prediction mode may be derived based on the template samples associated with the second sub-partition, and the second sub-partition may be decoded based on the second intra prediction mode. The intra prediction mode(s) for the sub-partitions of the coding block may be independently derived using decoder side intra mode derivation and/or template-based intra mode derivation.

For example, a prediction mode for the coding block may be derived based on template samples of the coding block. A sub-partition may be decoded based on the intra prediction mode derived based on the template samples of the coding block (e.g., at the block level) and an intra prediction mode derived based on the template samples of the sub-partition (e.g., at the sub-partition level).

For example, a video encoder may determine to use ISP mode to encode a coding block. The coding block may include multiple sub-partitions. For a first sub-partition in the coding block, an intra prediction mode may be derived based on the template samples associated with the first sub-partition. The first sub-partition may be encoded based on the intra prediction mode. For a second sub-partition in the coding block, an intra prediction mode may be derived based on the template samples associated with the second sub-partition, and the second sub-partition may be encoded based on that intra prediction mode.

For example, the probable prediction modes may be obtained for a sub-partition. The predictions of the template samples associated with the sub-partition may be computed based on the probable prediction modes, and the respective prediction errors that correspond to the probable prediction modes may be calculated (e.g., based on the predictions of template samples and the decoded reference samples of the template samples). An intra prediction mode may be selected from among the probable prediction modes, for example, based on prediction errors (e.g., to encode and/or decode the sub-partition).

A video decoding device may be configured to obtain a coding block having a plurality of sub-partitions. The video decoding device may derive an intra prediction mode for a sub-partition (e.g., each sub-partition) based on a template associated with the sub-partition (e.g., each sub-partition may have a template that is used to derive an intra prediction mode). The decoding device may decode the sub-partition (e.g., each sub-partition) based on the derived intra prediction mode for the sub-partition (e.g., as opposed to decoding based on an intra prediction mode derived for the coding block).

The video decoding device may reconstruct a first sub-partition, and a template for a second sub-partition (e.g., the next ordered sub-partition) may be based on one or more reconstructed samples of the first sub-partition. For example, the template for the second sub-partition may include one or more reconstructed samples in the first sub-partition.

The video decoding device may obtain a plurality of probable prediction modes associated with a sub-partition. The video decoding device may determine a plurality of predictions of a template associated with the sub-partition based on the plurality of probable prediction modes associated with the sub-partition. The video decoding device may, for example, derive an intra prediction mode based on the plurality of predictions of the template. The video decoding device may repeat this process with each sub-partition such that the intra prediction mode derived for each sub-partition is based on (e.g., based in part on) a plurality of predictions of a template associated with the respective sub-partition.

The video decoding device may, for each sub-partition, derive a second intra prediction mode based on the template associated with the respective sub-partition and the plurality of predictions of the template associated with the respective sub-partition. The video decoding device may decode each sub-partition based on the second intra prediction mode associated with the respective sub-partition.

In examples, a second prediction mode may be associated with the coding block. The video decoding device may decode each sub-partition based on the intra prediction mode associated with the respective sub-partition and the second prediction mode associated with the coding block.

The video decoding device may identify a plurality of candidate modes based on the first intra prediction mode, and the second intra prediction mode may be derived from the plurality of candidate modes. For example, a TIMD search may be performed on neighboring modes to the derived mode.

The video decoding device may, for example a sub-partition (e.g., each sub-partition), obtain a plurality of prediction errors associated with a template associated with the sub-partition and may derive an intra prediction mode for the sub-partition based on the plurality of prediction errors.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A, according to an embodiment.

FIG. 2 illustrates an example video encoder.

FIG. 3 illustrates an example video decoder.

FIG. 4 illustrates an example system in which various aspects and examples may be implemented.

FIG. 5A illustrates example reference samples for intra prediction.

FIG. 5B illustrates example sample substitution scenarios for intra prediction.

FIG. 6 illustrates example reference sample substitution for intra prediction.

FIGS. 7A, 7B, and 7C illustrate example intra prediction directions for intra prediction modes.

FIGS. 8A and 8B illustrate example wide-angle intra prediction.

FIG. 9 illustrates an example comparison of wide angular intra prediction modes to angular prediction modes.

FIG. 10 illustrates example planar mode interpolation.

FIG. 11 illustrates an example inter prediction mode scenario using reconstructed reference samples.

FIGS. 12A, 12B, and 12C illustrate an example template-based intra mode derivation (TIMD) procedure.

FIGS. 13A and 13B illustrate example sub-partitions of a coding unit based on block size.

FIG. 14 illustrates an example sub-partition scenario using H-scan order.

FIG. 15 illustrates an example scan order for a reference sample scenario.

FIG. 16A illustrates an example of transform unit scanning using Z-scan order.

FIG. 16B illustrates an example of transform unit scanning using H-scan order.

FIGS. 17A, 17B, and 17C illustrate examples of reordered intra sub partition (ISP) coding.

### DETAILED DESCRIPTION

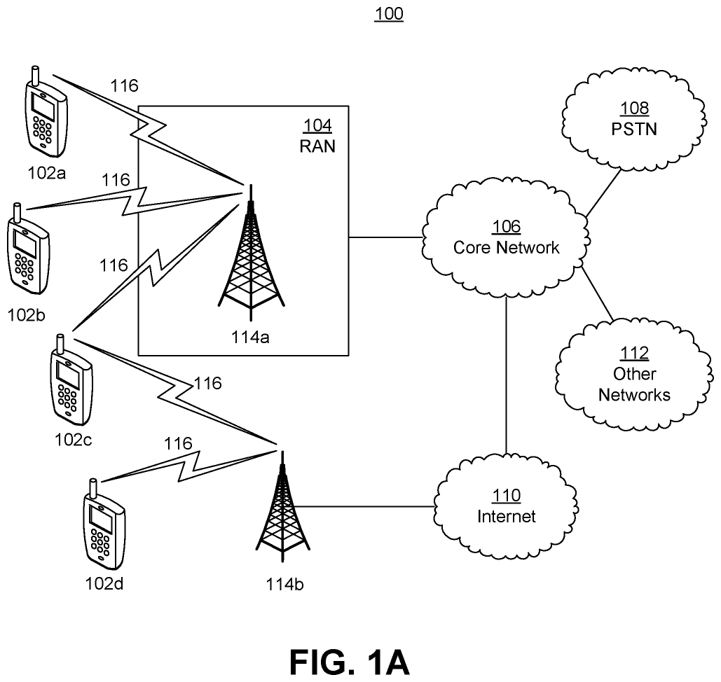

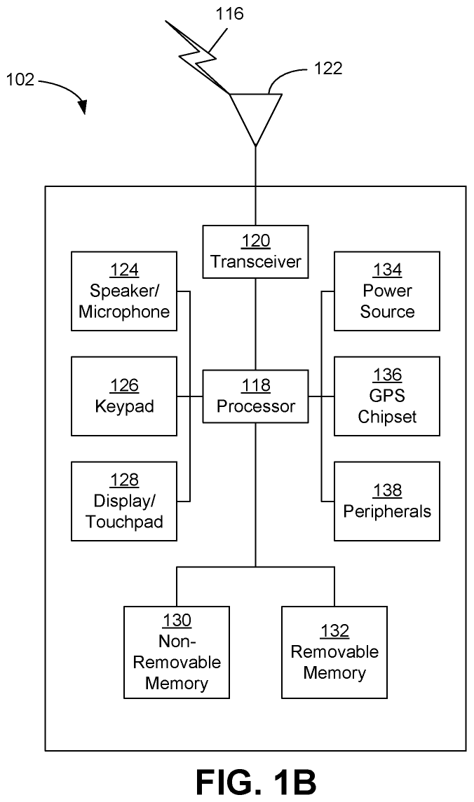

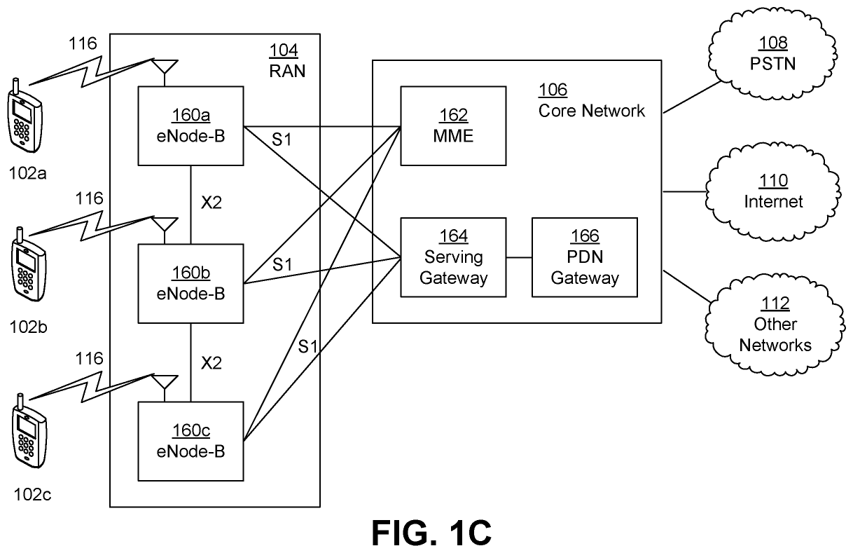

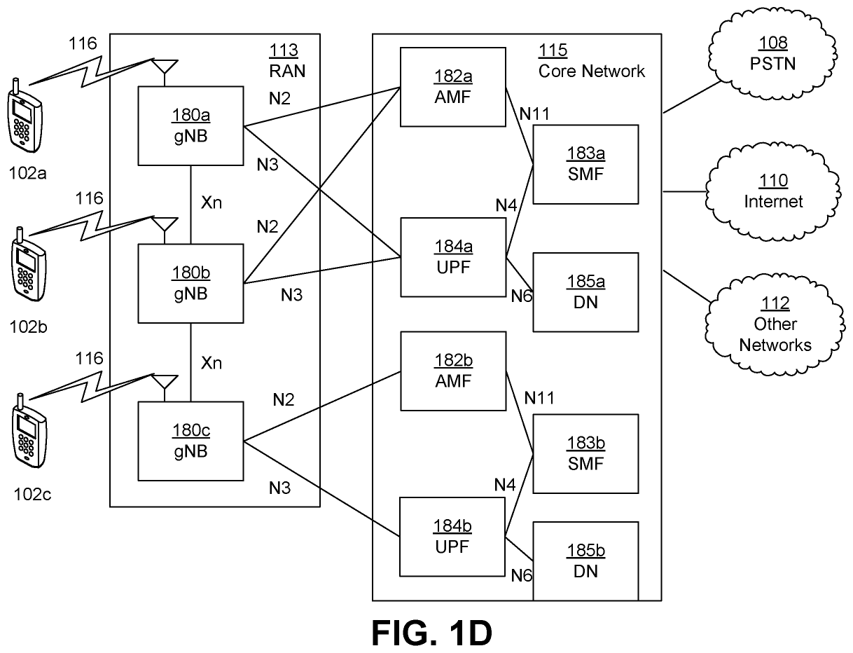

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

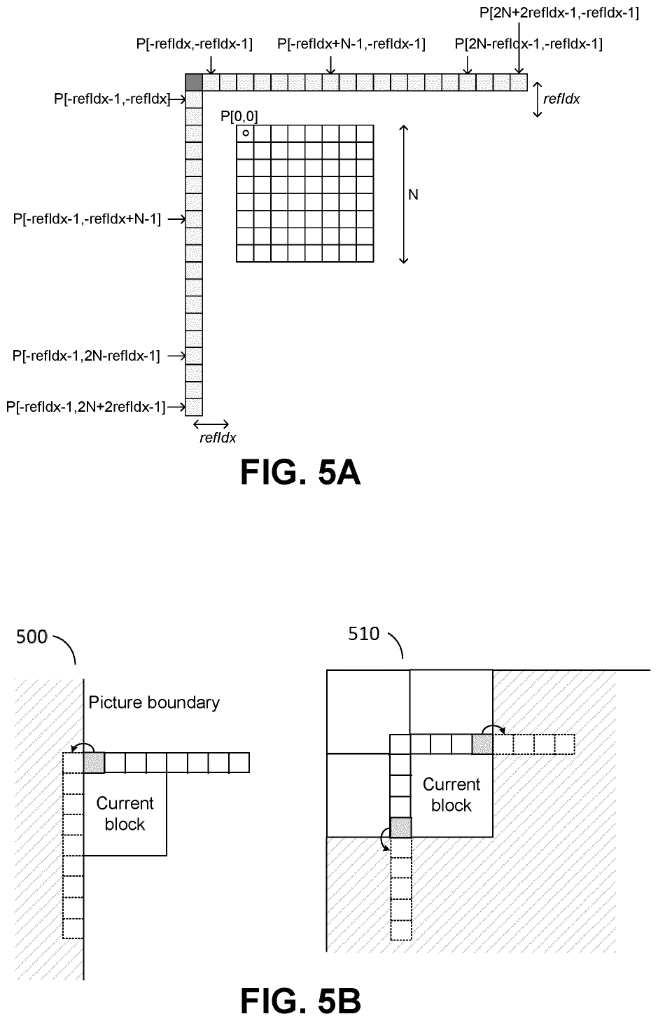

The aspects described and contemplated in this application may be implemented in many different forms. FIGS. 5-17 described herein may provide some examples, but other examples are contemplated. The discussion of FIGS. 5-17 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

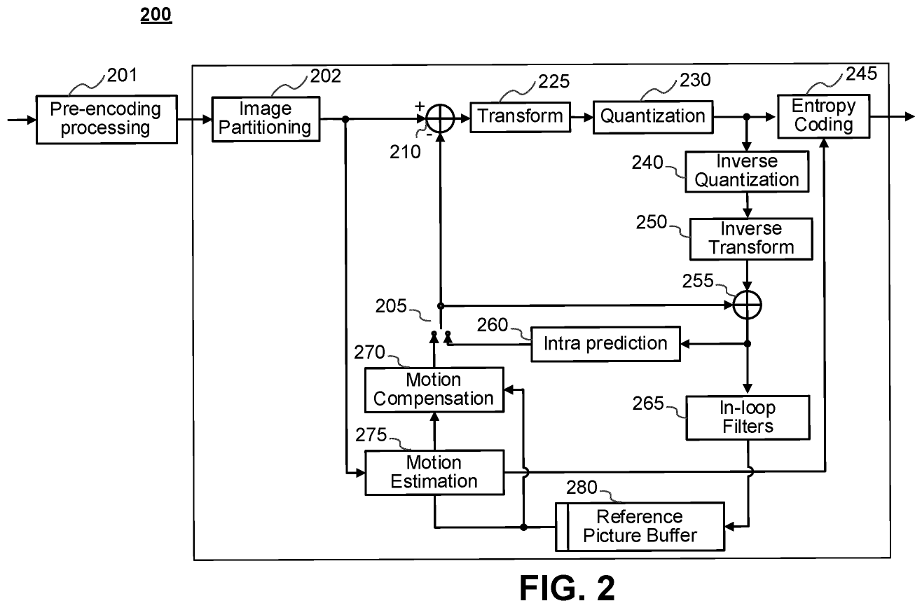

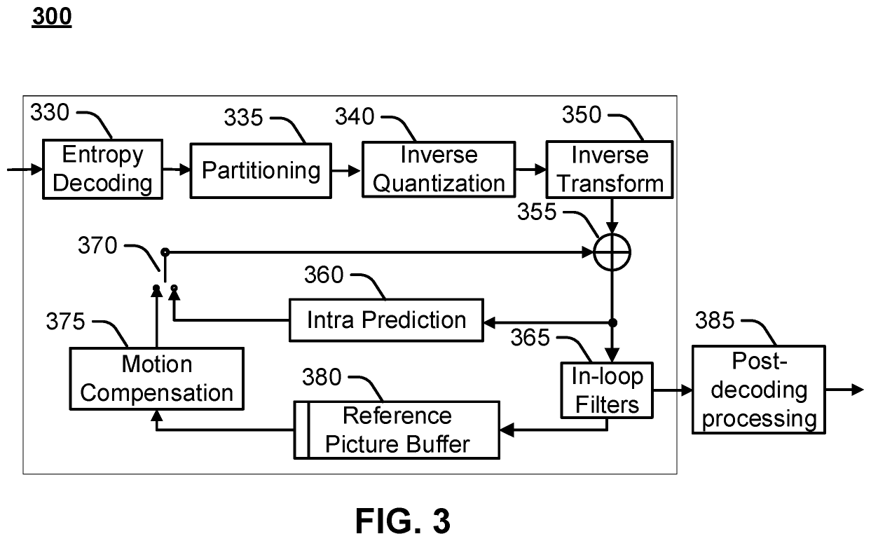

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as numbers of bits, bit depth, etc. These and other specific values are for purposes of describing examples and the aspects described are not limited to these specific values.

In the context of video coding, example intra sub partition (ISP) processes may be combined with template-based intra mode derivation (TIMD).

FIG. 2 illustrates an example of a video encoder 200 (e.g., a block-based hybrid video encoder). Variations of example encoder 200 are contemplated, but the encoder 200 is described below for purposes of clarity without describing all expected variations.

Before being encoded, the video sequence may go through a pre-encoding processing (201), for example, by doing one or more of applying a color transform to an input color picture (e.g., converting from RGB 4:4:4 to YCbCr 4:2:0) or performing a remapping of input picture components, for example, in order to obtain a transmission distribution that is resilient (e.g., more resilient) to compression (e.g., using a histogram equalization of one of the color components). Metadata may be associated with pre-processing and may be attached to the bitstream.

In the encoder 200, a picture may be encoded (e.g., may be encoded by the encoder elements) as described below. The picture to be encoded may be partitioned (202) and processed in units of, for example, Cus (Coding Units). Each unit may be encoded using, for example, either an intra mode or an inter mode. When a unit is encoded in an intra mode, intra prediction (260) may be performed. In an inter mode, motion estimation (275) and motion compensation (270) may be performed. The encoder may determine (205) whether one of intra mode or inter mode will be used for encoding the CU, the intra/inter decision may be indicated (e.g., by the encoder), for example, by a prediction mode indicator (e.g., a prediction mode flag). Prediction residuals may be calculated, for example, by subtracting (210) the predicted block from the original image block. In intra frames, Cus may be intra-predicted (e.g., in intra (I) frames) whereas in inter frames, a CU may be either intra-predicted or inter-predicted.

Prediction residuals may be transformed at 225 and quantized at 230. One or more of the quantized transform coefficients motion vectors, or other syntax elements (e.g., the picture partitioning information) may be entropy coded at 245 to output a bitstream. The encoder may apply quantization directly (e.g., and skip the transform) to the non-transformed residual transmission. The transform and quantization may be bypassed (e.g., by the encoder). For example, the residual may be coded (e.g., coded directly without the application of the transform or quantization processes).

An encoded block may be decoded (e.g., by the encoder) to provide a reference (e.g., a reference for further predictions). The quantized transform coefficients may be de-quantized at 240 and inverse transformed at 250 (e.g., inverse transformed to decode prediction residuals). The decoded prediction residuals and the predicted block may be combined at 255, and an image block may be reconstructed. In-loop filters at 265 may be applied to the reconstructed picture to perform, for example, deblocking/SAO (Sample Adaptive Offset)/ALF (Adaptive Loop Filter) filtering (e.g., to reduce encoding artifacts). The filtered image may be stored in a reference picture buffer at 280.

FIG. 3 illustrates a block diagram of an example video decoder 300. In the decoder 300, a bitstream may be decoded (e.g., by the decoder elements) as described herein. Video decoder 300 may perform a decoding pass reciprocal to the encoding pass as described in FIG. 2. As stated herein, the encoder 200 may perform video decoding as part of encoding video data.

In particular, the input of the video decoder may include video data (e.g., a video bitstream), which may be generated by the video encoder 200. The bitstream may be entropy decoded at 330 (e.g., to obtain one or more transform coefficients, prediction modes, motion vectors, or other coded information). The picture partition information may indicate how the picture is partitioned. The decoder may divide the picture according to the decoded picture partitioning information at 355. The transform coefficients may be de-quantized at 340 and inverse transformed at 350 to decode the prediction residuals. The predicted block may be obtained at 370 from intra prediction at 360 or motion-compensated prediction (e.g., inter prediction) at 375. The decoded prediction residuals and the predicted block may be combined at 355, and an image block may be reconstructed. In-loop filters may be applied to the reconstructed image at 365. The filtered image may be stored at a reference picture buffer at 380. The contents of the reference picture buffer 380 on the decoder side may be identical (e.g., for a picture) to the contents of the reference picture buffer 280 on the encoder 200 side.

The decoded picture may further go through post-decoding processing at 385, for example, one or more of an inverse color transform (e.g., conversion from YcbCr 4:2:0 to RGB 4:4:4) or an inverse remapping (e.g., performing the inverse of the remapping process performed in the pre-encoding processing at 201). The post-decoding processing may use metadata derived in the pre-encoding processing and may be signaled in video data (e.g., the bitstream). In an example, the decoded images (e.g., after application of the in-loop filters 365 and/or after post-decoding processing 385, if post-decoding processing is used) may be sent to a display device for rendering to a user.

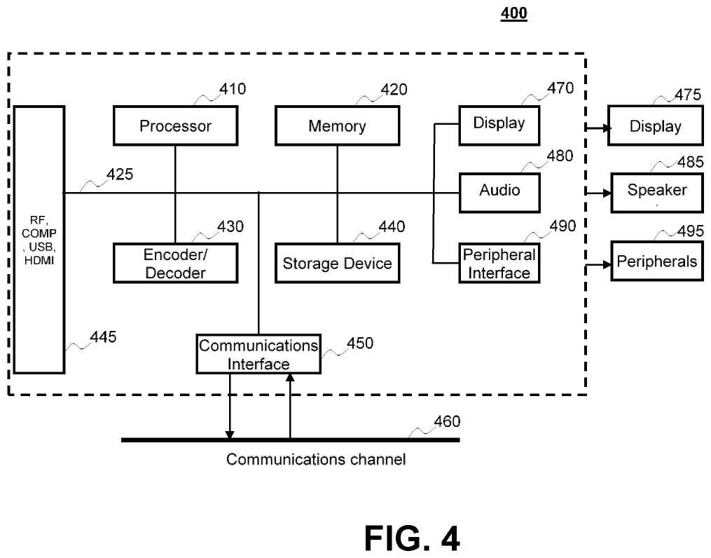

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video, portions of the decoded video, the bitstream, matrices, variables, and/or intermediate or final results from the processing of equations, formulas, operations, and/or operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or another device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and/or removable memory, as non-limiting examples. The processor 410 may be of any type appropriate to the technical environment, and can encompass one or more of microprocessors, general purpose computers, special purpose computers, and/or processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application can refer to “determining” various pieces of information. Determining the information can include one or more of, for example, estimating the information, calculating the information, predicting the information, or retrieving the information from memory. Obtaining can include receiving, retrieving, constructing, generating, and/or determining.

Further, this application can refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application can refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can (e.g., can also) be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on, or accessed or received from, a processor-readable medium.

Many examples are described herein. Features of examples can be provided alone or in any combination, across various claim categories and types. Further, examples can include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

These examples can be performed by a device with at least one processor. The device can be an encoder or a decoder. These examples can be performed by a computer program product which is stored on a non-transitory computer readable medium and includes program code instructions. These examples can be performed by a computer program comprising program code instructions. These examples can be performed by a bitstream comprising information representative of the coding block.

An intra prediction process may include reference sample generation, intra sample prediction, and/or post-processing of predicted samples. Intra sub partition (ISP) may be used to encode and/or decode a coding block using a single intra prediction mode (e.g., in up to four transform units (TUs)). For example, ISP may enable the use of reconstructed samples of a TU for a subsequent TU. Template-based intra mode derivation (TIMD) may use neighboring reconstructed samples to determine a best intra prediction mode to use on a coding block. In examples, TIMD may use neighboring reconstructed samples (e.g., reconstructed samples of a template associated with a sub-partition) to derive an intra prediction mode of a sub-partition (e.g., a later ordered sub-partition). TIMD and ISP may be used jointly.

FIG. 5A illustrates an example reference sample generation process. In FIG. 5A, pixel values at co-ordinates (x, y) are indicated as P(x, y) relative to a current block starting at (0, 0). In examples, reference samples ref[ ] may be referred to as L-shape. For an example prediction unit (PU) of size N by N (illustrated at P[0, 0] in FIG. 5A), a row of 2N+2refIdx decoded samples may be formed from previously reconstructed top and top right pixels to the PU. A column of 2N+2refIdx samples may be formed from reconstructed left and below left pixels to the PU. As illustrated in FIG. 5A, in examples, the reference row and column of samples may be distant (e.g., a distance of refIdx) by more than one sample to the example PU. An index “mrlIdx” may be signaled to indicate such a distance value.

In intra prediction examples, a corner pixel (e.g., at a top-left position) may be used to fill a gap between references (e.g., top row and left column references). Reference sample substitution may be performed by copying missing samples from available samples (e.g. in a clockwise direction, an inverse clockwise direction, or a combination of the two).

FIG. 5B illustrates example reference sample generation processes in which samples on top or left may not be available. In FIG. 5B, a dashed area may correspond to a region of a picture not yet reconstructed and a dot-line area may correspond to a missing reference. In examples, samples may not be available because corresponding CUs may not be in a slice associated with the PU. In examples, a CU may be at a frame boundary (e.g., as illustrated in FIG. 5B at 500). In examples, a CU may be at bottom-right after a quadtree split (e.g., as illustrated in FIG. 5B at 510).

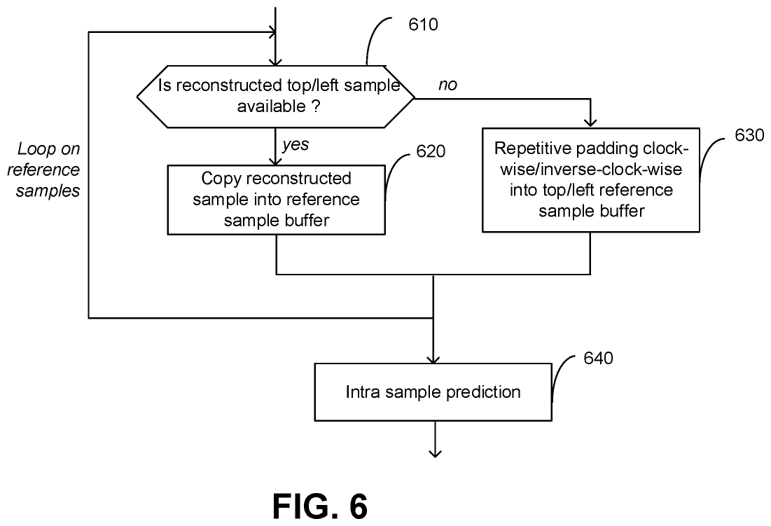

FIG. 6 illustrates example reference sample substitution for intra prediction 600. In examples, a sample (e.g., a top sample and/or a left sample) may be available. At 610, a check may be performed to determine if a reconstructed sample is available. If/when a sample is available, at 620 the sample may be copied into a reference sample buffer. If/when a sample is not available, at 630 repetitive padding may be performed to fill in a reference sample buffer. In examples, repetitive padding may refer to reference sample substitution as discussed herein. Intra sample prediction processes may be performed at 640.

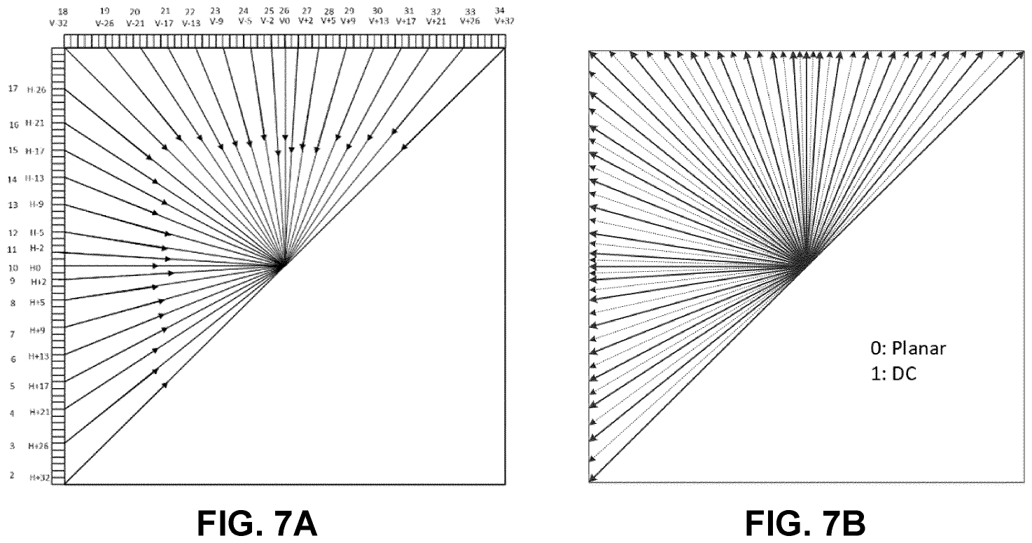

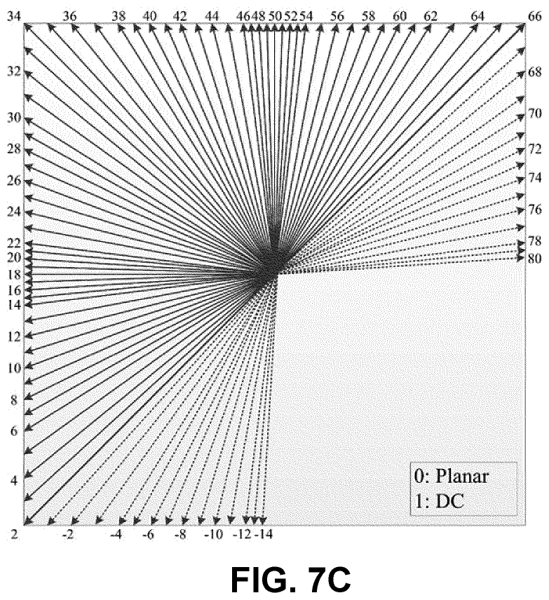

Intra sample prediction may include predicting pixels of a target CU based on a set of reference samples. Prediction modes may include planar and/or DC prediction modes (e.g., which may be used to predict smooth and gradually changing regions). Angular prediction modes (e.g., an angle defined from 45 degrees to −135 degrees in a clockwise direction) may be used to capture different directional structures. For square blocks, directional prediction modes (e.g., 33 directional modes for square blocks), which may be indexed (e.g., indexed from 2 to 34), may be used. The prediction modes may correspond to different prediction directions. FIGS. 7A-7C illustrate example prediction directions. Angular prediction modes may correspond to angular directions (e.g., 65 angular prediction modes may correspond to 33 angular directions), and angular directions (e.g., a further 32 angular directions) may correspond to a direction mid-way between an adjacent pair, for example as illustrated in FIG. 7B.

FIG. 7A illustrates example intra prediction directions. A number may denote the prediction mode index associated with the corresponding direction. The modes 2 through 17 may indicate horizontal predictions (H−26 to H+32), and the modes 18 through 34 may indicate vertical predictions (V−32 to V+32). FIG. 7B illustrates intra prediction (e.g., for square blocks). Modes less than 34 may indicate horizontal predictions. Modes greater than 34 may indicate vertical predictions. FIG. 7C illustrates available (e.g., all available) intra prediction directions. Dashed lines may indicate wide angle intra prediction modes (WAIP). The indices −1 through −14 illustrated in FIGS. 7B-7C may be remapped to go from 1 through −12 (e.g., such that angular mode indices are continuous). Modes −15 (e.g., remapped to −13) and 81 may not be present in FIG. 7, as block sizes (e.g., no allowed block sizes) may not use modes −15 (e.g., remapped to −13) and 81, but modes −15 (e.g., remapped to −13) and 81 may be handled by reference code.

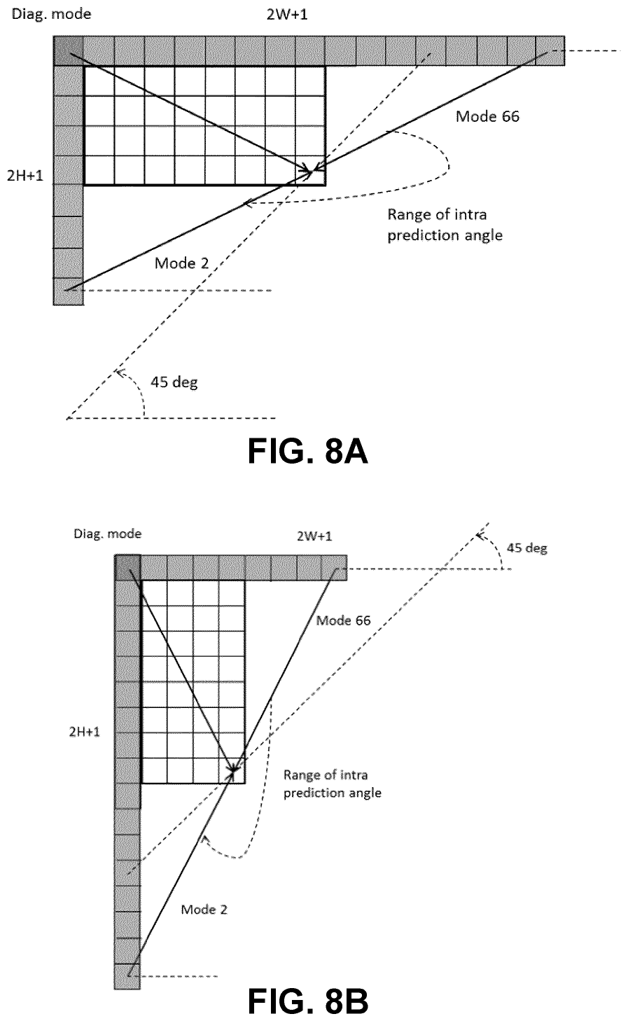

In examples, directional intra prediction may include wide-angle intra prediction modes (e.g., for non-square blocks). FIGS. 8A-8B illustrate example non-square blocks (e.g., FIG. 8A depicts a block wider than high and FIG. 8B depicts a block higher than wide).

In intra prediction examples, predictor samples on reference arrays may be copied along a corresponding direction inside a target PU. Predictor samples may have locations (e.g., integral locations that may correspond to associated reference sample locations). In examples, predictor sample locations may have fractional parts (e.g., predictor sample locations may correspond to two reference samples). In fractional part examples, predictor samples may be interpolated using the nearest reference samples (e.g., which may involve post-processing of predicted samples). For example, a linear interpolation of two nearest reference samples may be performed to compute the predictor sample value. For example, 4-tap filters (e.g., fT[ ]) may be used to compute the predictor sample value (e.g., such filters may be selected depending on the intra mode direction).

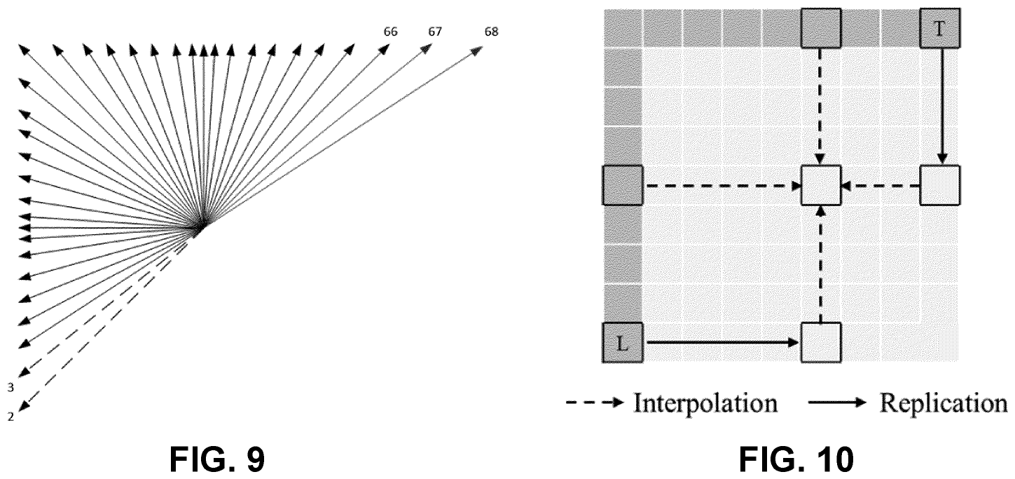

FIG. 9 illustrates an example non-square block (e.g., a non-square block whose width is strictly larger than its height) with angular modes replaced by wide angular modes. As shown in FIG. 9, wide-angle intra prediction directions may be used (e.g. 67 and 68).

Table 1, below, provides example indices of intra prediction modes replaced by wide-angle modes.

TABLE 1
indices of the intra prediction modes
replaced by wide-angular modes

| | replaced intra prediction | Added angular |
|---|---|---|
| Width/height | modes indices | modes |
| 2 | 2 to 7 | 67 to 72 |
| 4 | 2 to 11 | 67 to 76 |
| 8 | 2 to 13 | 67 to 78 |
| 16 | 2 to 15 | 67 to 80 |
| 32 | 2 to 16 | 67 to 81 |
| 1 | None | None |
| 1/2 | 61 to 66 | −4 to 1 |
| 1/4 | 57 to 66 | −8 to 1 |
| 1/8 | 55 to 66 | −10 to 1 |
| 1/16 | 53 to 66 | −12 to 1 |
| 1/32 | 52 to 66 | −13 to 1 |

In examples, DC prediction mode may fill in a prediction using an average of the samples in an L-shape. In some examples (e.g., those featuring a non-square CU) DC prediction mode may use average of reference samples of the longer side.

In examples, planar mode prediction may involve interpolating reference samples spatially. FIG. 10 illustrates example planar mode prediction. Example prediction modes may use reconstructed reference sample substitution. Block prediction may be based on reconstructed reference samples situated in a neighboring template. For example, local illumination compensation (LIC) model may modify inter prediction samples with a linear model, for example:

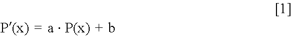

P′ may be a corrected prediction, P may be an inter-prediction, x may be a sample position, and (a, b) may be illumination compensation parameters (e.g. corresponding to a LIC model).

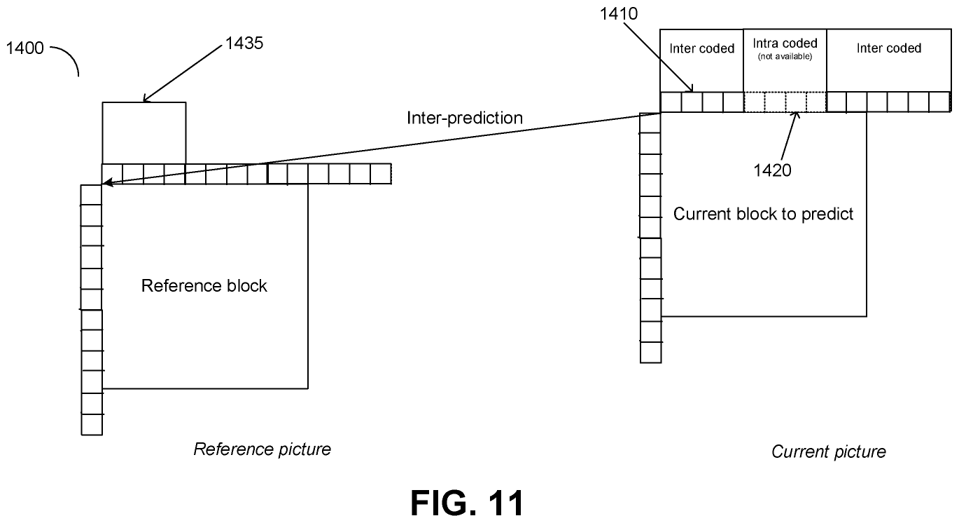

FIG. 11 illustrates an example scenario 1400 involving inter prediction mode using reconstructed reference samples. LIC model parameters may be derived with some reconstructed samples neighboring to a current block 1410 associated with co-located neighboring samples in the reference block 1435. In some examples, reconstructed reference samples may be unavailable (e.g. if additional conditions have restricted access to some reconstructed samples 1420; such conditions may be based on reducing implementation complexity, e.g. limiting memory access, limiting pipelined operations per block to reconstruct, etc.). For example, a limiting condition may be to prevent access to reconstructed samples of neighboring blocks coded in intra while reconstructing a current block in inter mode. In such examples, reference sample substitution such as repetitive padding may be applied.

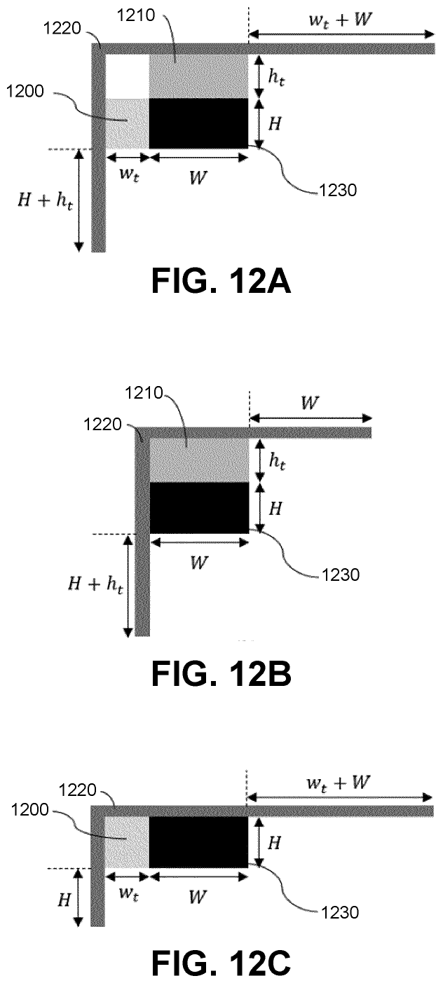

In examples, template-based intra mode derivation (TIMD) may be performed to derive prediction mode(s) for a coding block. Intra prediction mode derivation via TIMD may be applied (e.g., in a similar manner) on encoder and decoder sides for a given luminance, such as CB 1230 shown in FIGS. 12A-12C. An (e.g., each) intra prediction mode (e.g., supplemented with default modes) in the MPM list of the luminance CB may be used to compute a prediction of the template (100 and 1210) of the luminance CB from the decoded reference samples of the template (102). The SATD between the prediction and the template of the luminance CB may be calculated. The intra prediction mode(s) (e.g., two intra prediction modes) with minimum (e.g., smallest) SATDs may be selected as the TIMD mode(s). The set of directional intra prediction modes (e.g., for TIMD) may be extended (e.g., from 65 to 129), for example, by inserting a direction between each solid arrow and neighboring arrow in FIG. 9. The set of possible intra prediction modes derived via TIMD may gather modes (e.g., 131 modes). One or more intra prediction modes (e.g., two intra prediction modes) may be retained from the first pass of tests involving the MPM list and may be supplemented with default modes. For each retained intra prediction mode that is not PLANAR or DC, closest extended directional intra prediction mode(s) (e.g., the two closest extended directional intra prediction modes) may be tested. The SATD(s) between the prediction computed using the closest extended directional intra prediction mode(s) and the template of the luminance CB may be calculated. The intra prediction mode(s) with the minimum (e.g., smallest) SATDs may be selected as the TIMD mode(s).

The set of directional intra prediction modes may be extended from 65 to 129 and the intra prediction modes substitution may be adapted. Table 2, below, provides example replacement intra prediction mode indices.

TABLE 2
indices of the intra prediction modes
replaced by wide-angular modes

| condition | replaced intra prediction modes indices |
|---|---|
| W/H == 2 | [\|2, 12\|] |
| W/H == 4 | [\|2, 20\|] |
| W/H == 8 | [\|2, 24\|] |
| W/H == 16 | [\|2, 28\|] |
| W/H == 32 | [\|2, 30\|] |
| W/H == 1 | none |
| H/W == 2 | [\|120, 130\|] |
| H/W == 4 | [\|112, 130\|] |
| H/W == 8 | [\|108, 130\|] |
| H/W == 16 | [\|104, 130\|] |
| H/W == 32 | [\|102, 130\|] |

FIGS. 12A-12C illustrate example templates of the current luminance CB and decoded reference samples of the template used in TIMD. In FIG. 12A, the template of the luminance CB may not go out of the bounds of the current frame. The current W×H luminance CB 1230 may be surrounded by its fully available template, made of a wₜ×H portion on its left side at 1200 and a W×hₜ portion above it at 1210. During the TIMD derivation step, a tested intra prediction mode may predict the template of the current luminance CB from the set of 1+2wₜ+2W+2hₜ+2H decoded reference samples 1220 of the template. wₜ may equal two (2) if W≤8; otherwise, wₜ may equal 4. hₜ may equal two (2) if H≤8; otherwise hₜ may equal 4.

FIGS. 12B and 12C illustrate examples where at least a portion of the template of the luminance CB may be out of the bounds of the current frame. In FIG. 12B, the current W×H luminance CB 1230 may be surrounded by its template with its W×hₜ portion above it at 1201 available. During the TIMD derivation step, a tested intra prediction mode may predict the template of the current luminance CB from the set of 1+2W+2hₜ+2H decoded reference samples at 1220 of the template. In FIG. 12C, the current W×H luminance CB 1230 may be surrounded by its template with only its wₜ×H portion on its left side at 1200 available. During the TIMD derivation step, a tested intra prediction mode many predict the template of the current luminance CB from the set of 1+2wₜ+2W+2H decoded reference samples at 1220 of the template.

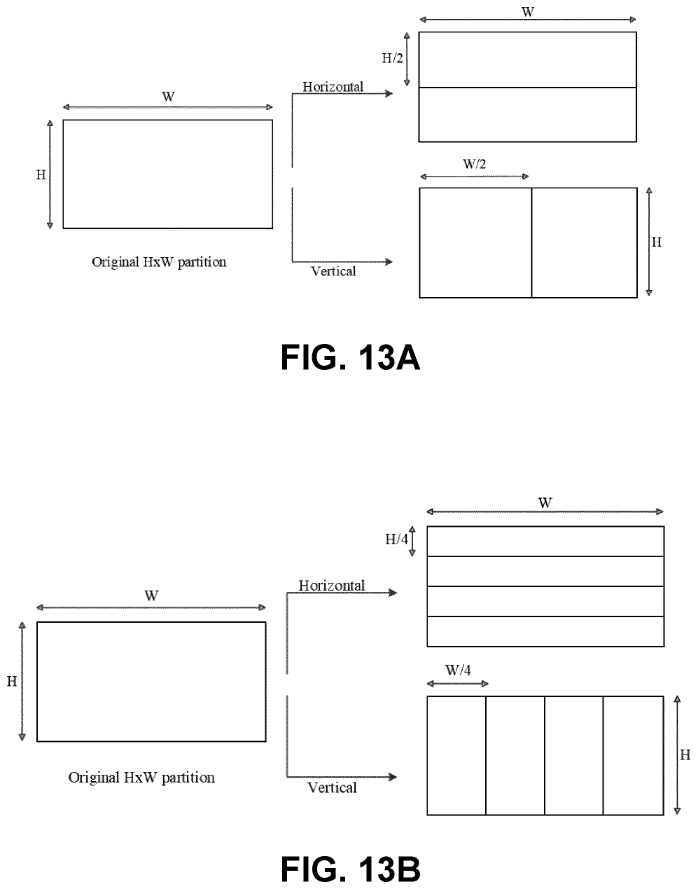

Example intra sub partition (ISP) modes are discussed. In examples, ISP may divide luma intra-predicted blocks vertically or horizontally into two or four sub-partitions depending on block size. For example, minimum block size for ISP may be 4×8 (or 8×4). If a block size is greater than 4×8 (or 8×4), then the block may be divided into four sub-partitions. FIGS. 13A and 13B illustrate examples of partitioning. Example sub-partitions illustrated in FIGS. 13A and 13B may have at least 16 samples.

In ISP examples, a dependence of 1×N/2×N subblock prediction on the reconstructed values of previously decoded 1×N/2×N subblocks of the coding block may not be possible. A minimum width of prediction for subblocks may be four samples. For example, an 8×N (N>4) coding block that is coded using ISP with vertical split is split into two prediction regions each of size 4×N and four transforms of size 2×N. A 4×N coding block coded using ISP with vertical split may be predicted using as full 4×N block; in some such examples, four transforms each of 1×N may be used. ISP may support transform sizes of 1×N and 2×N. In ISP examples, transforms of 4×N regions may be performed in parallel. For example, if a 4×N prediction region contains four 1×N transforms, there may be no transform in the horizontal direction; a transform in the vertical direction may be performed as a single 4×N transform in the vertical direction. In examples involving a 4×N prediction region containing two 2×N transform blocks, transform operations of the two 2×N blocks in either direction (e.g., horizontal or vertical) may be conducted in parallel. In examples, processing such smaller blocks may avoid delay compared to processing 4×4 regular-coded intra blocks.

In examples, a reconstructed sample of a sub-partition may be obtained by adding a residual signal to a prediction signal. Such residual signal may be generated by processes such as entropy decoding, inverse quantization, inverse transform, etc. Reconstructed sample values of example sub-partitions may be available to generate a prediction of a next sub-partition, and each sub-partition may be processed repeatedly. In examples, the first sub-partition to be processed may contain the top-left sample of the CU and may proceed downwards (e.g., for a horizontal split) or rightwards (e.g., for a vertical split). In examples, reference samples used to generate sub-partition prediction signals may be located at the left and above sides. The sub-partitions may share an intra mode.

ISP may interact with other coding tools. ISP may interact with one or more of: multiple reference line (MRL), entropy coding coefficient group size, CBF coding, transform size restriction(s), or an MTS indication (e.g., an MTS flag).

ISP may interact with MRL. For example, if a block has a MRL index other than 0, ISP mode information may not be sent to the decoder (e.g., the ISP coding mode may be inferred to be 0).

ISP may interact with entropy coding efficiency group size. For example, the size of entropy coding coefficient subblocks may be modified to have 16 samples. Subblock sizes may affect blocks produced by ISP (e.g., in which one or more dimensions are less than four samples). In other examples, coefficient groups may keep the 4×4 dimension. Table 3, below, provides example group sizes corresponding to example block sizes.

TABLE 3
entropy coding coefficient group size

| Block Size | Coefficient Group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

ISP may interact with CBF coding. In examples, at least one sub-partition may have a non-zero CBF (e.g., examples involving CBF coding). For example, if n is the number of sub-partitions and the first n−1 sub-partitions have produced a zero CBF, then the CBF of the n-th sub-partition may be inferred to be 1.

ISP may interact with transform size restriction. For example, ISP transforms with a length larger than 16 points may use DCT-II.

ISP may interact with a MTS indication (e.g., an MTS flag). For example, if an MTS CU flag is set to 0, it may not be sent to the decoder. In examples, the encoder may not perform RD tests for various available transforms corresponding to resulting sub-partitions. A transform choice for ISP mode may be selected according to, for example, the intra mode, the processing order, and/or the block size utilized. In such examples, no signalling may be required. To illustrate, let t_{H} and t_{V} be the horizontal and the vertical transforms selected respectively for the w×h sub-partition, where w is the width and h is the height. The transform may be selected according to the following rules: if w=1 or h=1, then there is no horizontal or vertical transform respectively; if w≥4 and w≤16, t_{H}=DST-VII, otherwise, t_{H}=DCT-II; if h≥4 and h≤16, t_{V}=DST-VII, otherwise, t_{V}=DCT-II.

In ISP mode, intra modes (e.g., all 67 intra modes) may be allowed. PDPC may be applied if corresponding width and height are at least 4 samples long. In examples, reference sample filtering (e.g., reference smoothing) and the condition for intra interpolation filter selection may be avoided and cubic (DCT-IF) filter may be applied for fractional position interpolation in ISP mode.

TIMD and ISP may be used on the same coding block. For a first sub-partition in the coding block, a first intra prediction mode may be derived based on the template samples associated with the first sub-partition. The first sub-partition may be decoded based on the intra prediction mode. For a second sub-partition in the coding block, a second intra prediction mode may be derived based on the template samples associated with the second sub-partition, and the second sub-partition may be decoded based on the second intra prediction mode.

TIMD modes, timdMode and timdModeSecondary, may be derived for the first sub-partition, for example. A first sub-partition may be predicted using timdMode (e.g., pu1) and using timdModeSecondary (e.g., pu2). Predictions pu1 and pu2 may be averaged (e.g., a weighted average) to compute a prediction of the first sub-partition. The first sub-partition may be quantized and transformed to derive a reconstructed first sub-partition. The second sub-partition may be predicted, based at least in part on the reconstructed samples from the first sub-partition.

For example, the video decoding device may reconstruct a first sub-partition, and a template for a second sub-partition (e.g., the next ordered sub-partition) may be based on one or more reconstructed samples of the first sub-partition. For example, the template for the second sub-partition may include one or more reconstructed samples in the first sub-partition.

In some examples, TIMD may be performed independently for the ISP sub-partitions in a coding block. For a sub-partition, a TIMD process may be performed to determine an intra prediction mode for the sub-partition based on a template associated with the sub-partition.

For example, the probable prediction modes may be obtained for a sub-partition. The predictions of the template samples associated with the sub-partition may be computed based on the probable prediction modes, and the respective prediction errors that correspond to the probable prediction modes may be calculated (e.g., based on the predictions of template samples and the decoded reference samples of the template samples). An intra prediction mode may be selected from among the probable prediction modes, for example, based on prediction errors (e.g., to encode and/or decode the sub-partition).

In examples, the secondary TIMD mode (e.g., for blending) may be computed independently for each sub-partition. For example, for each sub-partition, a second intra prediction mode may be derived based on the template associated with the respective sub-partition and the plurality of predictions of the template associated with the respective sub-partition. Each sub-partition may be encoded and/or decoded based on the second intra prediction mode associated with the respective sub-partition.

A corresponding coding process may include one or more of the following: mode(s) for a first sub-partition (e.g. timdMode and timdModeSecondary) may be derived from TIMD on the first sub-partition (e.g., rather than the CU); the first sub-partition may be predicted using timdMode and timdModeSecondary (e.g. pu1 and pu2, respectively); pu1 and pu2 may be averaged (e.g. using a weighted average) to compute a prediction of the first sub-partition; quantization and transform may be applied to the first sub-partition to derive the reconstructed first sub-partition; or for a second sub-partition, TIMD modes may be selected and the process may be repeated. The second sub-partition prediction may be based on the reconstructed samples of the first sub-partition.

In examples, a secondary TIMD mode may be the mode derived by the TIMD search on the whole block (e.g., the main TIMD mode). Each sub-partition may be encoded and/or decoded based on the intra prediction mode specifically derived for the respective sub-partition and the second prediction mode associated with the coding block. For example, one mode may be searched on the CU and, for each sub-partition, one (e.g., only one) mode may be searched. A corresponding coding process may include one or more of the following: a TIMD mode on the CU may be determined (e.g. timdModeSecondary); a TIMD mode may be determined on the first sub-partition (e.g. timdMode); a first sub-partition may be predicted using timdMode and timdModeSecondary (e.g. pu1 and pu2, respectively); predictions pu1 and pu2 may be averaged (e.g. using a weighted average) to compute a prediction of the first sub-partition; quantization and transform may be applied to the first sub-partition to derive the reconstructed first sub-partition; or for a second sub-partition, TIMD modes may be selected, and the process may be repeated for the sub-partitions. The second sub-partition prediction may be based on the reconstructed samples of the first sub-partition.

In some examples, timdMode may be derived for the whole CU. For a sub partition, a TIMD search may be performed on the neighboring modes. For example, TIMD search on a sub partition may be performed on modes within +/−N of the timdMode of the previous sub-partition (e.g., where N=3).

In some examples, the wide angles (WA) to use may not be selected from the size of the full CU. In such examples, available modes in this combination may correspond to modes available. In examples where the first and secondary modes are not computed for the same block size, the WA used may be based on the block size at which they are computed. For example, where the first mode is derived for a sub-partition and the secondary mode is derived for the whole CU, the first mode may use WA for the sub-partition size and the secondary mode may use WA for the CU size.

It will be appreciated that examples discussed herein may also apply for decoder side intra mode derivation (DIMD), in examples involving a combination of DIMD and ISP. For example, for a sub-partition, a DIMD process may be performed to determine an intra prediction mode for the sub-partition based on neighboring samples of the sub-partition. The reconstructed samples in the sub-partition may be used to derive intra prediction mode(s) for the next sub-partition in the coding block.

In some examples combining DIMD and ISP, the first Planar mode may be derived from the full coding unit and/or subsequent weighted angular modes may be derived from neighboring reconstructed samples from ISP sub-partitions. In some such examples the DIMD process may be performed independently (e.g., for each sub-partition).

In examples, coding order of intra sub-partitions may be changed (e.g., to allow for more availability of reference samples).

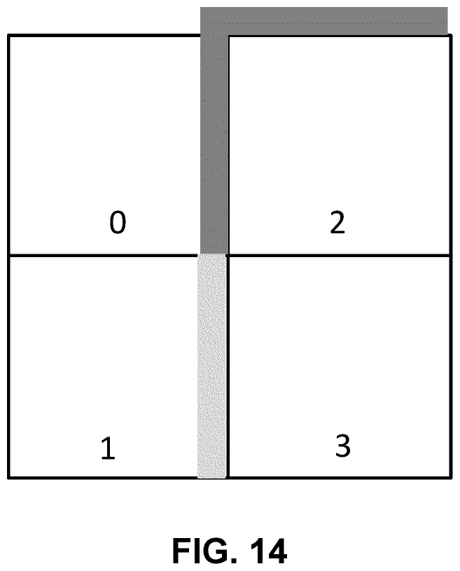

In some examples, a Quad-Tree (QT) split may be used for ISP, and coding order may be changed from raster scan (e.g., Z-scan) to H-scan, for example when reference samples from the left side are more likely to be relevant. FIG. 14 illustrates an example using H-scan in which bottom-left samples (e.g., 1 in FIG. 14) may be available when coding partition 2. For example, coding order may be changed when, for the first TU in the current CU, the IPM derived by TIMD from the TIMD template of the first TU is an angular mode whose index is smaller than 18 (e.g., corresponding to a fully horizontal mode).

In examples, coding order of ISP may depend on the intra prediction mode derived by TIMD for the first TU of the current CU using ISP and/or the availability of the neighboring decoded reference samples of each remaining TU. Determining coding order of the current CU using both ISP and TIMD may depend on the intra prediction mode derived by TIMD for the first TU of the current CU and/or the availability of neighboring decoded reference samples of each remaining TU.

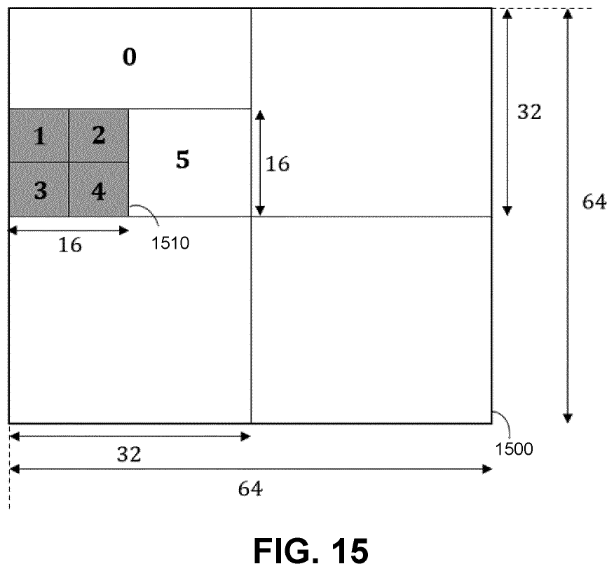

FIG. 15 illustrates an example (1500) where a luminance CB is split into four luminance TBs via ISP using Quad-Tree (QT) split, inside the luminance channel of an intra-slice (with CTU size 128). The example luminance CTB, not lying on any slice border, may be split via QT. The first resulting luminance CB may be split via QT, yielding the 4 32×32 luminance CBs illustrated in FIG. 15. Given the partitioning of the first 32×32 luminance CB, all the decoded reference samples located above and left of the luminance CB of interest (1510) may be available.

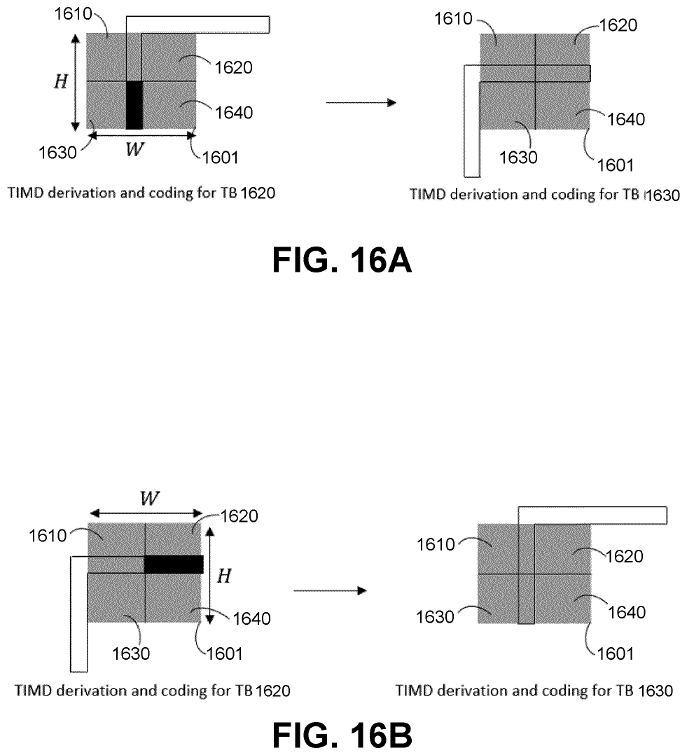

FIG. 16(A) illustrates an example scenario in which ISP follows a Z-scan (e.g., (1610), (1620), (1630), and (1640)), resulting in decoded reference samples around the luminance TB (1620) available for the TIMD derivation step and the application of the derived prediction mode. Decoded reference samples around the luminance TB (1630) may be available during TIMD derivation and application of the derived mode to predict.

FIG. 16B illustrates an example scenario in which ISP follows a H-scan (e.g., (1610), (1620), (1630), resulting in decoded reference samples around the luminance TB (1630) being available for the TIMD derivation step and the application of the derived mode to predict (1630). Decoded reference samples around the luminance TB (1620) may be available for TIMD derivation and the application of the derived mode to predict (1620). In examples where the intra prediction mode derived via TIMD for the first luminance TB (1610) is vertical positive, modes derived via TIMD for the luminance TB (1620) and the luminance TB (1630) may be vertical positive. In such examples, the availability of the decoded reference samples located above each successive luminance TB in the current luminance CB may be maximized. In examples involving a luminance CB split via ISP using QT, if the intra prediction mode derived via TIMD for the first luminance TB is vertical positive and the decoded reference samples located above (and above-right) the current luminance CB are available, ISP may choose Z-scanning. In examples involving a luminance CB split via ISP using QT, if the intra prediction mode derived via TIMD for the first luminance TB is horizontal positive and the decoded reference samples located on the left side (and bottom-left) of the current luminance CB are available, ISP may choose H-scanning. In examples, a default ISP scanning may be picked.

In examples involving a luminance CB split via ISP using QT, if the intra prediction mode derived via TIMD for the first luminance TB is one of the last (e.g. last eight) vertical positive modes and the decoded reference samples located above (and above-right) the current luminance CB are available, ISP may choose Z-scanning. In examples involving a luminance CB split via ISP using QT, if the intra prediction mode derived via TIMD for the first luminance TB is one of the first horizontal positive modes and the decoded reference samples located on the left side (and bottom-left) of the current luminance CB are available, ISP may choose H-scanning.

In examples, an indicator may be included in video data (e.g., coded in a bitstream) to indicate scanning order.

In examples, top-left partition (e.g. partition 0) may be coded last (e.g., to allow for reference samples to the right or bottom side to be available). Intra modes that may not be usable in some coding (e.g., directions from the right side, or from below) could be used. In such examples (e.g. including when QT-split is used with ISP) 3600 may be available for intra prediction angles. In example where the right side of a coding block is available, the top-right reference samples may be taken as reconstructed samples from the right side.

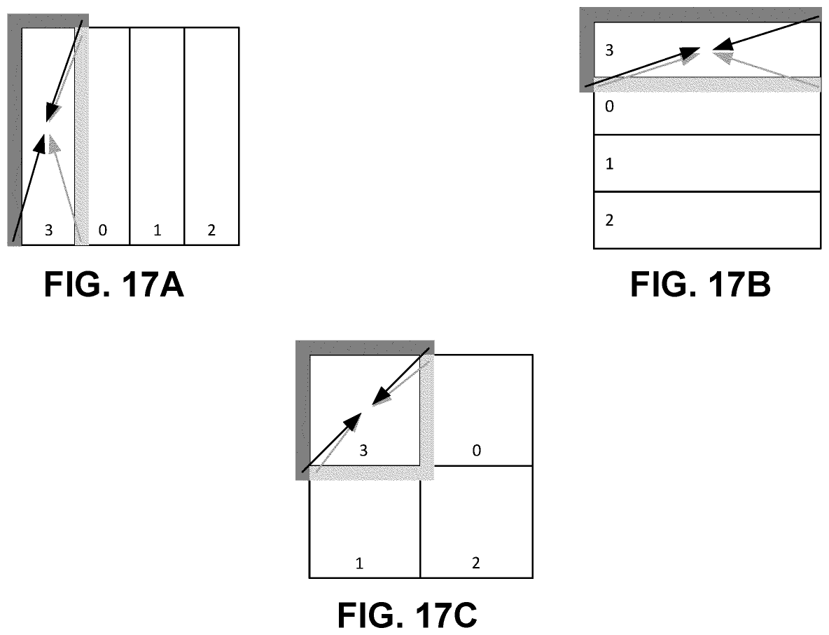

FIGS. 17A-C illustrate examples of reordering of ISP coding (e.g. to allow more directional modes). In darker grey are the reference samples accessible, allowing for regular IPMs in black. In lighter grey are the reference samples available from the new coding order, allowing the new directional angles portrayed in light grey.

In examples, the coding order may be modified to DIMD (e.g., to use additional modes).

In examples, a combination of ISP and TIMD may be applied when ISP sub-partitions are big enough for TIMD to be used normally. For example, ISP-TIMD combination may be enabled when the coding unit size has both width and height bigger than, for example, 8. In some examples, the combination may be enabled when a split is horizontal and the width is, for example, bigger than 8. In some examples, tests may be made directly on the sub-partition size to ensure that both width and height are bigger than, for example, 4.

In examples, the TIMD process may accommodate smaller block sizes induced by ISP sub-partition (e.g. to allow TIMD to be used on each sub-partition regardless of size). In examples, when the width of a sub-partition is, for example, 2 or 1, the TIMD process may use (e.g., may only use) the left template for SAD estimation of each mode.

In examples, if the width of the sub partition is 2 or 1, the left template width may be set to 1. In some examples, if the width of a sub partition is 2 or 1, only vertical modes may be considered, for example using the above reference samples. In examples, restrictions may vary depending on whether the width and/or height of a sub partition is 1 or 2.

1.-34. (canceled)

35. A video decoding device comprising:
a processor configured to:
obtain a coding block that comprises a plurality of sub-partitions;
for a first sub-partition of the plurality of sub-partitions, derive a first intra prediction mode based on a first template associated with the first sub-partition;
decode the first sub-partition based on the first intra prediction mode;
for a second sub-partition of the plurality of sub-partitions, deriving a second intra prediction mode based on a second template associated with the second sub-partition; and
decode the second sub-partition based on the second intra prediction mode.

36. The video decoding device of claim 35, wherein the processor is further configured to:
reconstruct the first sub-partition, wherein the second template associated with the second sub-partition comprises at least one reconstructed sample in the first sub-partition.

37. The video decoding device of claim 35, wherein the processor is further configured to:
obtain a plurality of probable prediction modes associated with the first sub-partition;
determine a plurality of predictions of the first template associated with the first sub-partition based on the plurality of probable prediction modes associated with the first sub-partition, wherein deriving the first intra prediction mode is further based on the plurality of predictions of the first template;
obtain a plurality of probable prediction modes associated with the second sub-partition; and
determine a plurality of predictions of the second template associated with the second sub-partition based on the plurality of probable prediction modes associated with the second sub-partition, wherein deriving the second intra prediction mode is further based on the plurality of predictions of the second template.

38. The video decoding device of claim 37, wherein the processor is further configured to:
for the first sub-partition, derive a secondary first intra prediction mode based on the first template associated with the first sub-partition and the plurality of predictions of the first template, wherein decoding the first sub-partition is further based on the secondary first intra prediction mode; and
for the second sub-partition, derive a secondary second intra prediction mode based on the second template associated with the second sub-partition and the plurality of predictions of the second template, wherein the second sub-partition is further based on the secondary second intra predication mode.

39. The video decoding device of claim 35, wherein the processor is further configured to:
obtain a secondary prediction mode associated with the coding block, wherein decoding the first sub-partition is further based on a secondary prediction mode, and wherein decoding the second sub-partition is further based on the secondary prediction mode.

40. The video decoding device of claim 35, wherein the processor is further configured to:
obtain a plurality of probable prediction modes associated with the coding block;
determine a plurality of predictions of the coding block based on the plurality of probable prediction modes associated with the coding block;
for the first sub-partition, derive a secondary first intra prediction mode based on the plurality of predictions of the coding block, wherein decoding the first sub-partition is further based on the secondary first intra prediction mode; and
for the second sub-partition, derive a secondary second intra prediction mode based on the plurality of predictions of the coding block, wherein decoding the second sub-partition is further based on the secondary second intra prediction mode.

41. The video decoding device of claim 35, wherein the processor is further configured to:
identify a plurality of candidate modes based on the first intra prediction mode, wherein the second intra prediction mode is derived from the plurality of candidate modes.

42. The video decoding device of claim 35, wherein the processor is further configured to:
obtain a plurality of prediction errors associated with the first template associated with the first sub-partition, wherein deriving the first intra prediction mode is based on the plurality of prediction errors associated with the first template; and
obtain a plurality of prediction errors associated with the second template associated with the second sub-partition, wherein deriving the second intra prediction mode is based on the plurality of prediction errors associated with the second template.

43. A video decoding method comprising:
obtaining a coding block that comprises a plurality of sub-partitions;
for a first sub-partition of the plurality of sub-partitions, deriving a first intra prediction mode based on a first template associated with the first sub-partition;
decoding the first sub-partition based on the first intra prediction mode;
for a second sub-partition of the plurality of sub-partitions, deriving a second intra prediction mode based on a second template associated with the second sub-partition; and
decoding the second sub-partition based on the second intra prediction mode.

44. The method of claim 43, further comprising:
reconstructing the first sub-partition, wherein the second template associated with the second sub-partition comprises at least one reconstructed sample in the first sub-partition.

45. The method of claim 43, further comprising:
obtaining a plurality of probable prediction modes associated with the first sub-partition; and
determining a plurality of predictions of the first template associated with the first sub-partition based on the plurality of probable prediction modes associated with the first sub-partition, wherein deriving the first intra prediction mode is further based on the plurality of predictions of the first template;
obtaining a plurality of probable prediction modes associated with the second sub-partition; and
determining a plurality of predictions of the second template associated with the second sub-partition based on the plurality of probable prediction modes associated with the second sub-partition, wherein deriving the second intra prediction mode is further based on the plurality of predictions of the second template.

46. The method of claim 45, further comprising:
for the first sub-partition, deriving a secondary first intra prediction mode based on the first template associated with the first sub-partition and the plurality of predictions of the first template, wherein decoding the first sub-partition is further based on the secondary first intra prediction mode; and
for the second sub-partition, deriving a secondary second intra prediction mode based on the second template associated with the second sub-partition and the plurality of predictions of the second template, wherein decoding the second sub-partition is further based on the secondary second intra predication mode.

47. The method of claim 43, further comprising:
obtaining a secondary prediction mode associated with the coding block, wherein decoding the first sub-partition is further based on a secondary prediction mode, and wherein decoding the second sub-partition is further based on the secondary prediction mode.

48. The method of claim 9, further comprising:
obtaining a plurality of probable prediction modes associated with the coding block;
determining a plurality of predictions of the coding block based on the plurality of probable prediction modes associated with the coding block;
for the first sub-partition, deriving a secondary first intra prediction mode based on the plurality of predictions of the coding block, wherein decoding the first sub-partition is further based on the secondary first intra prediction mode; and
for the second sub-partition, deriving a secondary second intra prediction mode based on the plurality of predictions of the coding block, wherein decoding the second sub-partition is further based on the secondary second intra prediction mode.

49. The method of claim 43, further comprising:
identifying a plurality of candidate modes based on the first intra prediction mode, wherein the second intra prediction mode is derived from the plurality of candidate modes.

50. The method of claim 43, further comprising:
obtaining a plurality of prediction errors associated with the first template associated with the first sub-partition, wherein deriving the first intra prediction mode is based on the plurality of prediction errors associated with the first template; and
obtaining a plurality of prediction errors associated with the second template associated with the second sub-partition, wherein deriving the second intra prediction mode is based on the plurality of prediction errors associated with the second template.

51. A video encoding device comprising:
a processor configured to:
obtain a coding block that comprises a plurality of sub-partitions;
for a first sub-partition of the plurality of sub-partitions, derive a first intra prediction mode based on a first template associated with the first sub-partition;
encode the first sub-partition based on the first intra prediction mode;
for a second sub-partition of the plurality of sub-partitions, deriving a second intra prediction mode based on a second template associated with the second sub-partition; and
encode the second sub-partition based on the second intra prediction mode.

52. The video encoding device of claim 51, wherein the processor is further configured to:
reconstruct the first sub-partition, wherein the second template associated with the second sub-partition comprises at least one reconstructed sample in the first sub-partition.

53. The video encoding device of claim 51, wherein the processor is further configured to:
obtain a plurality of probable prediction modes associated with the first sub-partition;
determine a plurality of predictions of the first template associated with the first sub-partition based on the plurality of probable prediction modes associated with the first sub-partition, wherein deriving the first intra prediction mode is further based on the plurality of predictions of the first template;
obtain a plurality of probable prediction modes associated with the second sub-partition; and
determine a plurality of predictions of the second template associated with the second sub-partition based on the plurality of probable prediction modes associated with the second sub-partition, wherein deriving the second intra prediction mode is further based on the plurality of predictions of the second template.

54. The video encoding device of claim 53, wherein the processor is further configured to:
for the first sub-partition, derive a secondary first intra prediction mode based on the first template associated with the first sub-partition and the plurality of predictions of the first template, wherein encoding the first sub-partition is further based on the secondary first intra prediction mode; and for the second sub-partition, derive a secondary second intra prediction mode based on the second template associated with the second sub-partition and the plurality of predictions of the second template, wherein the second sub-partition is further based on the secondary second intra predication mode.
